(19) United States
(12) Patent Application Publication
(10) Pub. No.: US 2001/0036026 A1
(43) Pub. Date: Nov. 1, 2001

(54) Efficient sensorless rotational vibration and shock compensator for hard disk drives with higher TPI

(75) Inventors: YangQuan Chen, Singapore (SG); MingZhong Ding, Singapore (SG); LeeLing Tan, Singapore (SG); KianKeong Ooi, Singapore (SG)

Correspondence Address: Schwegman, Lundberg, Woessner & Kluth, P.A., Attn: Richard E. Billion, P.O. Box 2938, Minneapolis, MN, 55402, US

(73) Assignee: Seagate Technology LLC

(21) Appl. No.: 09/792,310

(22) Filed: Feb. 23, 2001

Related U.S. Application Data
(60) Provisional application No. 60/184,718, filed on Feb. 24, 2000.

(51) Int. Cl. G11B 27/36; G11B 21/02

(52) U.S. Cl. 360/31; 360/77.02; 360/75; 360/69

(57) ABSTRACT

A low cost sensorless technique for attenuating an actuating force experienced by the actuator arm assembly due to an external vibration and shock during a track following operation includes, in one example embodiment, measuring an applied signal and a position error signal during the track following operation within a sampling time. Then, the method includes the step of computing an acceleration signal from the measured position error signal. Further, the method includes comparing the acceleration signal with the applied signal to obtain a correction signal. Then, the force experienced by the actuator arm due to the external vibration and shock is attenuated by filtering the correction signal using one or more low-pass frequency filters.

### RELATED APPLICATION

This application claims the benefit of U.S. Provisional Application Ser. No. 60/184,718, filed Feb. 24, 2000 under 35 U.S.C. 119(e).

### FIELD OF THE INVENTION

The present invention relates to the field of mass storage devices. More particularly, this invention relates to an improved track following technique for a disc drive in a vibratory environment.

### BACKGROUND OF THE INVENTION

One key component of any computer system is a device to store data. Computer systems have many different places where data can be stored. One common place for storing massive amounts of data in a computer system is on a disc drive. The most basic parts of a disc drive are an information storage disc that is rotated, an actuator that moves a transducer to various locations over the disc, and electrical circuitry that is used to write and read data to and from the disc. The disc drive also includes circuitry for encoding data so that it can be successfully retrieved and written to the disc surface. A microprocessor controls most of the operations of the disc drive as well as passing the data back to the requesting computer and taking data from a requesting computer for storing to the disc.

The transducer is typically placed on a small ceramic block, also referred to as a slider, that is aerodynamically designed so that it flies over the disc. The slider is passed over the disc in a transducing relationship with the disc. Most sliders have an air-bearing surface (ABS) which includes rails and a cavity between the rails. When the disc rotates (generally, at rotational speeds of 10,000 RPM or higher), air is dragged between the rails and the disc surface causing pressure, which forces the head away from the disc. At the same time, the air rushing past the cavity or depression in the air-bearing surface produces a negative pressure area. The negative pressure or suction counteracts the pressure produced at the rails. The slider is also attached to a load spring, which produces a force on the slider directed toward the disc surface. The various forces on the slider equilibrate, so that the slider flies over the surface of the disc at a particular desired fly height. The fly height is the distance between the disc surface and the transducing head, which is typically the thickness of the air lubrication film. This film eliminates the friction and resulting wear that would occur if the transducing head and disc were in mechanical contact during disc rotation. In some disc drives, the slider passes through a layer of lubricant rather than flying over the surface of the disc.

Data is stored on the surface of the storage disc. Disc drive systems read and write information stored on tracks on storage discs. Transducers, in the form of read/write heads attached to the sliders, located on both sides of the storage disc, read and write information on the storage discs when the transducers are accurately positioned over one of the designated tracks on the surface of the storage disc. The transducer is also required to be moved to a target track. As the storage disc spins and the read/write head is accurately positioned above a target track, the read/write head can write data onto the storage disc. Similarly, reading data on a storage disc is accomplished by positioning the read/write head above a target track and reading the stored material on the storage disc. To write on or read from different tracks, the read/write head is moved radially across the tracks to a selected target track. The data is divided or grouped together on the tracks. In some disc drives, the tracks are a multiplicity of concentric circular tracks. In other disc drives, a track consists of a continuous spiral on one side of the disc drive. Each track on a disc surface in a disc drive is further divided into a number of short arcs called sectors. Servo feedback information is used to accurately locate the transducer head on to the tracks and sectors. The actuator assembly is moved to the required position and held very accurately during a read or write operation using the servo information.

The actuator assembly is composed of many parts that contribute to the operation required to accurately hold the read/write head in the proper position. There are two general types of actuator assemblies, a linear actuator and a rotary actuator. The rotary actuator includes a pivot assembly, an arm, a voice coil yoke assembly, and a head gimbal suspension assembly. The rotary actuator assembly pivots or rotates to reposition the transducer head over particular tracks on a disk. A suspension or load beam is part of the head gimbal suspension assembly. The rotary actuator assembly also includes a main body, which includes a shaft and bearing about which the rotary actuator assembly pivots. Attached to the main body are one or more arms. One or typically two head gimbal suspension assemblies are attached to the arm.

One end of the suspension is attached to the actuator arm assembly. The transducer head, also known as a read/write head, is found attached to the other end of the suspension. One end of the actuator arm assembly is coupled to a pivot assembly. The pivot assembly, in turn, is connected to a voice coil motor attached to a voice coil yoke on the main body of the actuator assembly. The other end of the actuator arm assembly is attached to the head gimbal suspension assembly. The head gimbal suspension assembly includes a gimbal to allow the read/write head to pitch and roll and follow the topography of the imperfect memory disc surface. The head gimbal assembly also restricts motion with respect to the radial and circumferential directions of the memory disc. The suspension assembly is coupled to the actuator arm assembly as part of the main body of the actuator assembly, which holds the pivot support and is coupled to the voice coil motor.

Fast read/write operation is critical to the performance of the hard disk. The hard disc drive is a mechanical device and actuator arms are cantilevered assemblies, which act as spring-mass-damper systems. The hard disc drive and the actuator arms are susceptible to vibrations at their natural frequencies. These vibrations could be excited by external forces, such as the one generated by the spindle motor or voice coil motor during positioning of the read/write head above a target track during a read/write operation or from other external sources. These resonant frequencies could affect the precise positioning of the head over the track, which would inevitably delay the read/write operation. As the capacity of the hard disc is increased to meet demands of increased storage requirements, the track widths are being progressively reduced. The slightest vibration in the actuator arm could off-track the head uncomfortably close to an adjacent track during a read/write operation. This can result in track encroachment and data corruption. Therefore, accurate placement of the read/write head is crucial to the utility of disc drives. In order to reliably read data from or write data onto a disk media surface of a disc drive, the read/write head must be positioned precisely over the track of the disc surface from which data is read or on which data is written. Failure to accurately position the read/write head over the desired track during a read operation can result in unreliable data retrieval. If the read/write head is improperly positioned during a write operation to the disc, not only may the written data be lost, but also data on adjacent tracks may be written over and destroyed.

To overcome the track encroachment and data corruption problem, a dual actuator or micro-actuator can be used. However, using a dual actuator increases the cost of producing the disc drives. Techniques such as zero acceleration path (ZAP) and rotational vibration feed forward (RVFF) can be also used to overcome the track encroachment and data corruption problems in a vibratory environment. But, as the ZAP is a technique used to compensate written-in repeatable run out error, this results in the actuator actually following a nearly straight track (zero acceleration path) instead of following the physically written in track. Whereas, RVFF is a technique that requires using an additional sensor such as an accelerometer or velocity transducer on the actuator arm to compensate for the track encroachment and data corruption problem, and this again results in increased production costs to manufacture disc drives in a low-cost high-volume environment.

What is needed, is a low cost disc drive that is less susceptible to the effects of rotational vibration and shock during the track following operations of the disc drive. What is also needed is a low cost disc drive that increases density of data stored on the media surface of the disc drive.

### SUMMARY OF THE INVENTION

A disc drive includes a servo controller and an actuator arm assembly. The actuator arm assembly includes an actuator and a transducer head. The actuator arm is coupled to the servo controller. The servo controller applies a signal to position the actuator arm assembly during a track following operation. The actuator arm assembly generates a position error signal during the track following operation. An analyzer coupled to the servo controller measures the applied signal to the actuator arm assembly within a sample time. Then the analyzer measures the position error signal generated by the actuator arm assembly and differentiates the measured position error signal to obtain an acceleration signal. Then a comparator coupled to the analyzer compares the applied signal with the computed acceleration signal. Then the analyzer obtains a correction signal based on the outcome of the comparison and applies the obtained correction signal to attenuate an actuating force induced on the actuator arm by a disturbance such as an external vibration and/or a shock.

In some embodiments, the disc drive further includes low pass filters coupled to the analyzer to further filter the correction signal to obtain a compensation signal. Then the servo controller applies the compensation signal to the actuator arm assembly to attenuate the actuator arm during the track following operation.

Also discussed is a method of attenuating an actuating force induced by external vibration and shock on an actuator arm assembly of a disc drive during a track following operation. The method begins with the step of measuring an applied signal to an actuator arm assembly, and further measuring a position error signal during the track following operation within a sampling time. Then, the method includes the step of computing an acceleration signal from the measured position error signal, and comparing the acceleration signal with the applied signal to obtain a correction signal. Further, the method includes attenuating the induced actuating force on the actuator arm assembly due to external vibration and shock using the obtained correction signal.

Advantageously, the method and apparatus described above provides a low cost technique of attenuating an actuating force induced by a disturbance such as, external vibration and/or shock on an actuator arm of the disc drive during a track following operation. Also, the above-described technique can increase the storage density by increasing the tracks per inch.

Additional features and benefits will become apparent upon a review of the following figures and their associated detailed description.

### BRIEF DESCRIPTION OF THE DRAWINGS

FIG. 1 is an exploded view of a disc drive with a multiple disc stack.

FIG. 2 is a flow diagram of a method to attenuate an actuating force experienced by the actuator arm assembly shown in FIG. 1 due to external vibration and shock during a track following operation.

FIG. 3 is a schematic representation of the disc drive of FIG. 1 including portions of major components used in the present subject matter.

FIG. 4 illustrates measured Bode plots of error transfer function obtained when computed induced force is passed through different combinations of low pass filters.

FIG. 5 illustrates measured Bode plots of torque level disturbance sensitivity transfer functions when computed induced force is passed through different combinations of low pass filters.

FIG. 6 is a schematic view of a computer system.

### DESCRIPTION OF THE PREFERRED EMBODIMENT

In the following detailed description of the preferred embodiments, reference is made to the accompanying drawings, which form a part hereof, and in which are shown by way of illustration specific embodiments in which the invention may be practiced. It is to be understood that other embodiments may be utilized and structural changes may be made without departing from the scope of the present invention.

The invention described in this application is useful with all mechanical configurations of disc drives having either rotary or linear actuation. In addition, the invention is also useful in all types of disc drives including hard disc drives, zip drives, floppy disc drives and any other type of drives where unloading the transducer from a surface and parking the transducer may be desirable.

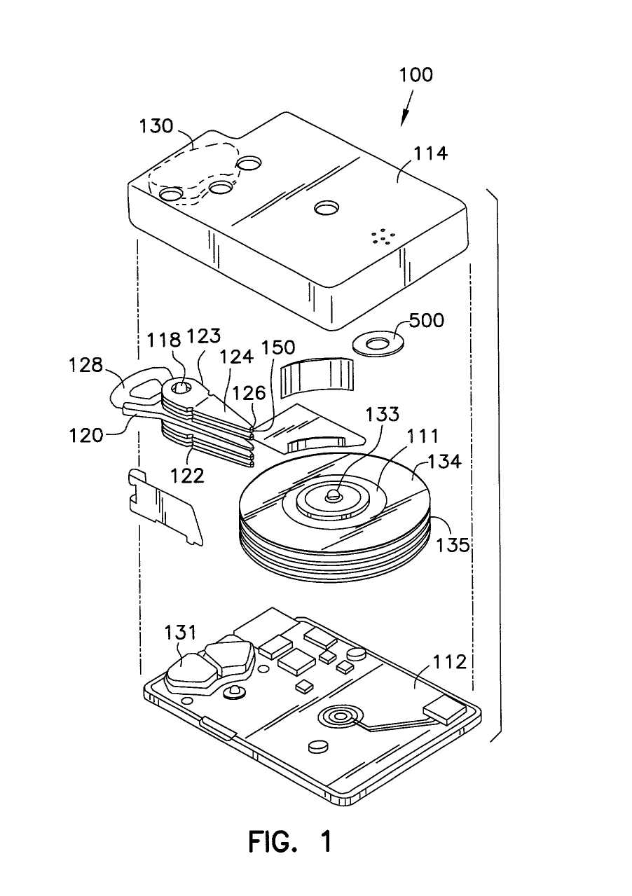

FIG. 1 is an exploded view of one type of a disc drive 100 having a rotary actuator. The disc drive 100 includes a housing or a base 112, and a cover 114. The base 112 and cover 114 form a disc enclosure. An inertia ring 500 is attached to the cover 114. Rotatably attached to the base 112 on an actuator shaft 118 is an actuator assembly 120. The actuator assembly 120 includes a comb-like structure 122 having a plurality of actuator arms 123. Attached to the separate arms 123 on the comb 122, are load beams or load springs 124. Load beams or load springs are also referred to as suspensions. Attached at the end of each load spring 124 is a slider 126, which carries a magnetic transducer 150. The slider 126 with the transducer 150 form what is often called the head. The head with the load spring 124 is often called the head gimbal assembly. It should be noted that many sliders have one transducer 150 and that is what is shown in the figures. It should also be noted that this invention is equally applicable to sliders having more than one transducer, such as what is referred to as a magneto resistive (MR) head in which one transducer 150 is generally used for reading and another is generally used for writing. On the end of the actuator arm assembly 120 opposite the load springs 124 and the sliders 126 is a voice coil 128.

Attached to the base 112 is a first magnet 130 and a second magnet 131. As shown in FIG. 1, the first magnet 130 is associated with cover 114 and the second magnet 131 is associated with the base 112. The first and second magnets 130, 131, and the voice coil 128 are the key components of a voice coil motor, which applies a force to the actuator assembly 120 to rotate it about the actuator shaft 118. Also mounted to the base 112 is a spindle motor. The spindle motor includes a rotating portion called the spindle hub 133. In this particular disc drive, the spindle motor is within the hub. In FIG. 1, a number of discs 134 are attached to the spindle hub 133. Each of the discs 134 has a recording surface 135. Only one disc 134 is numbered for the sake of clarity. In other disc drives a single disc or a different number of discs may be attached to the hub. The invention described herein is equally applicable to disc drives which have a plurality of discs as well as disc drives that have a single disc. The invention described herein is also equally applicable to disc drives with spindle motors, which are within the hub 133 or under the hub.

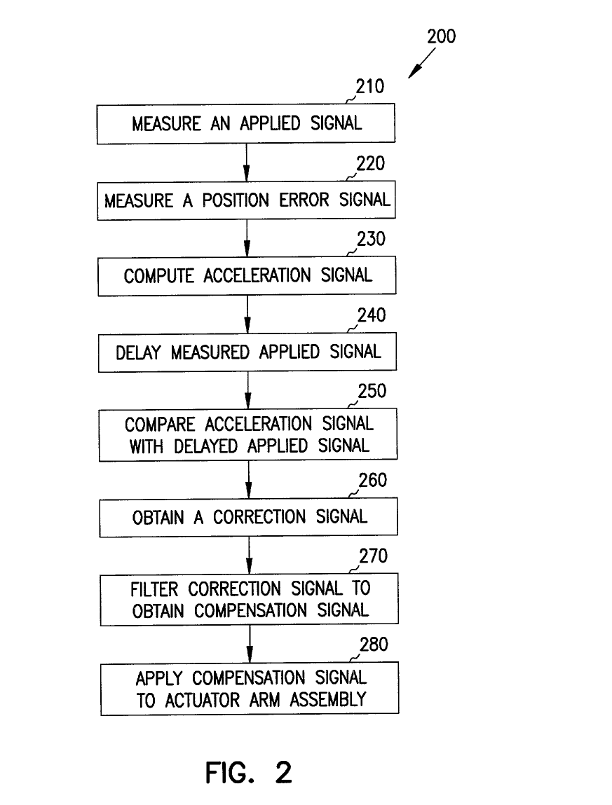

FIG. 2 is a flow diagram illustrating a method 200 of attenuating an actuating force induced by a disturbance such as an external vibration and/or a shock on an actuator arm assembly of the disc drive 100 shown in FIG. 1. In this example embodiment shown in FIG. 2, the method 200 begins with step 210 of measuring an applied signal by a servo controller to the actuator arm assembly during a track following operation within a sampling time. The applied signal can be a voltage or current applied to the actuator arm by the servo controller to move the actuator arm assembly to a specified track during the track following operation. Step 220 includes measuring a position error signal during the track following operation within the sampling time. During track following, the servo information sensed by the transducer head is demodulated to generate a position error signal (PES), which is an indication of the position error of the transducer head away from the track center.

Step 230 includes computing an acceleration signal from the measured PES within the sampling time. The acceleration signal is obtained by differentiating the PES signal. In some embodiments, this is accomplished by inputting the PES into a double-digital differentiator to recover acceleration information from the PES. The disc drive actuator assembly is roughly a double integrator and therefore, approximates to Pₙ⁻¹(z⁻¹), that is an inverse of the nominal drive model Pₙ(z⁻¹).

In one example embodiment the Pₙ⁻¹(z⁻¹) is derived by using a double-digital differentiator (DDD) which generally yields the acceleration signal of interest, because the low frequency of interest in the measure PES is between 20 Hz to 500 Hz. A lumped gain kₗᵤₘₚ is measured in drive level and the nominal drive model is approximated to

$$P ( s ) \approx \frac{{k}_{lump}}{{s}^{2}} .$$

where s is a Laplacian operator.

Therefore, Pₙ⁻¹(z⁻¹) is simplified by the DDD with a known parameter kₗᵤₘₚ. The DDD used in this invention is not simply a finite difference or central difference. To reduce the noise and rounding-off problem due to fixed-point computation, the following DDD by the well-known Savitzky-Golay smoothing filter is used:

$${u}_{a}^{′} ( k ) = \frac{1}{7 {k}_{lump}} \{ 2 y ( k ) - y ( k - 1 ) - 2 y ( k - 2 ) - y ( k - 3 ) + 2 y ( k - 4 ) \} .$$

where uₐ′(k) is an estimated acceleration signal from PES signal y(k). The lumped gain kₗᵤₘₚ is a static gain between VCM (voice coil motor's control signal) and the PES signal.

Step 240 can include delaying the measured applied signal to reduce a phase mismatch between the measured applied signal and the computed acceleration signal.

Steps 250 and 260 include comparing the computed acceleration signal with the measured applied signal to obtain a correction signal. Steps 270 and 280 include attenuating the induced actuating force on the actuator arm assembly due to the external vibration and shock based on the outcome of the comparing. This is accomplished in steps 270 and 280 by filtering the correctional signal for low frequency external vibration to obtain a compensation signal and then applying the compensation signal to the actuator arm assembly to attenuate the induced actuating force, respectively. In some embodiments, the measured PES signal is compared a set of PES threshold values and the computed correction signal is filtered using one or more low frequency filters based on the outcome of the comparing of PES threshold values with the PES. In some embodiments, the one or more filters comprise one or more first order Butterworth low pass filters (LPFs). For example, when the PES exceeds the largest of the PES threshold values (when the shock or vibration is very large), then only one of the one or more filters will be used to filter the compensation signal to achieve a maximum possible attenuation even though the phase loss is large (since the phase loss is not a primary concern, the primary concern is to reject the large shock or vibration). When the PES signal is less than or equal to smallest of the threshold values (when the vibration or shock is not very significant), then the compensation signal is filtered using all of the one or more filters to keep the phase loss to a minimum. This type of using one or more filters (Q-filters) to filter the compensation signal based on the threshold values provides a best possible compromise between the performance gain and phase loss in the present invention.

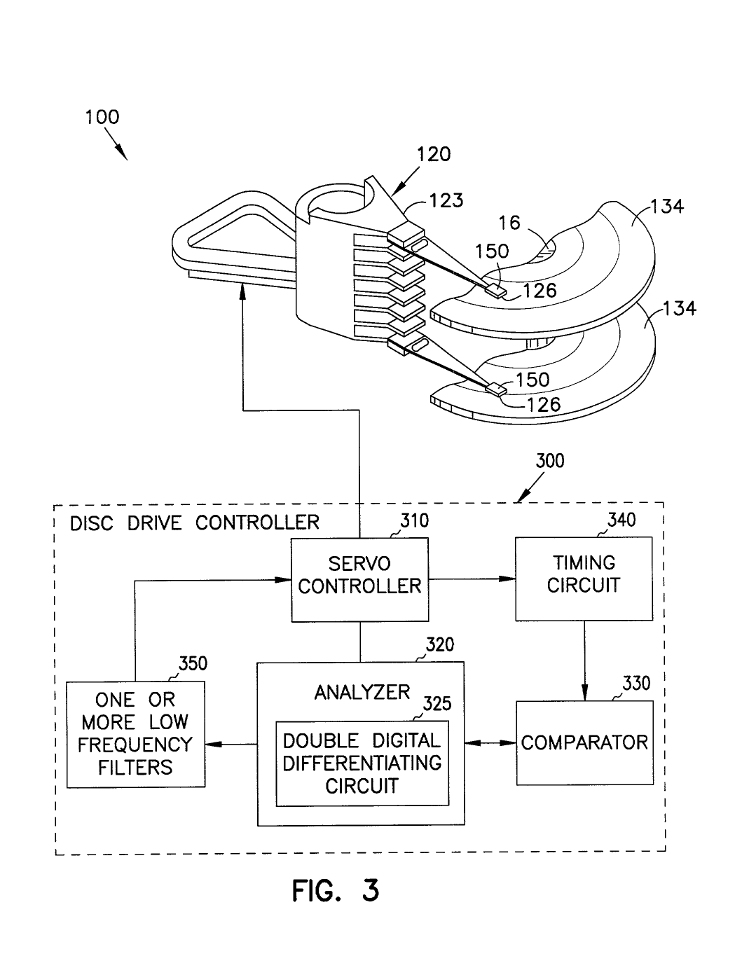

Referring now to FIG. 3, there is shown a selected portions of a disc drive 100 and schematic representation of a disc drive controller 300 used in generating a correction signal for attenuating an actuating force induced by external vibration and shock on an actuator arm assembly 120 of the disc drive 100. In this embodiment, the disc drive 100 includes at least one disc 134 rotatably attached to a base through a shaft 16. The disc drive 100 also includes an actuator 123 having a transducer head 126 and transducer 150 for reading and writing to the at least one disc 134. The actuator 123 carrying transducer head 126 is in a transducing relation with respect to the disc 134.

The disc drive controller 300 including a servo controller 310 is coupled to the actuator arm assembly 120. The actuator arm assembly 120 is capable of moving the transducer head 126 based on at least in part on an applied signal and correction signals from the servo controller 310. The actuator arm assembly 120 is also capable of generating a position error signal (PES) on a position of the transducer head 126 over a current track during a track following operation. The disc drive controller 300 further includes an analyzer 320 coupled to the servo controller 310 measures the applied signal by the servo controller to the actuator arm assembly. Further, the analyzer 320 measures the position error signal during the track following operation within a sample time. Then, the analyzer 320 computes an acceleration signal from the measured position error signal. The disc drive controller 300 further includes a comparator 330 coupled to the analyzer 320. The comparator 330 compares the measured applied signal with the computed acceleration signal. The computation of the acceleration signal is explained in detail with reference to FIG. 2. Then the analyzer 320 further computes a correction signal based on the outcome of the comparison by the comparator 330. Then the servo controller 310 attenuates an actuating force induced by external vibration and shock on the actuator arm assembly 120 by applying the correction signal to the actuator arm assembly 120.

In some embodiments, the disc drive controller 300 further includes a timing circuit 340 to reduce a phase mismatch between the measured applied signal and the computed acceleration signal. In some embodiments, the analyzer 320 further comprises a double-digital differentiating circuit 325 to differentiate the measured position error signal to compute the acceleration signal. In some embodiments, the comparator 330 further compares the position error signal to a set of threshold values and issues a command signal based on the outcome of the comparison. In some embodiments, the disc drive controller 300 further comprises one or more low pass filters 350 coupled to the analyzer 320 to filter the correction signal for low frequency external vibration based on the command signal to obtain a compensation signal. In some embodiments, the one or more filters comprise one or more first order Butterworth LPFs. For example, when the PES exceeds the largest of the PES threshold values (when the shock or vibration is very large), then only one of the one or more filters will be used to filter the compensation signal to achieve a maximum possible attenuation even though the phase loss is large. The phase loss is less of a concern, than rejecting a large shock or vibration. When the PES signal is less than or equal to smallest of the threshold values (when the vibration or shock is not very significant), then the compensation signal is filtered using all of the one or more filters to keep the phase loss to a minimum. This type of using one or more filters (Q-filters) to filter the compensation signal based on the threshold values provides a best possible compromise between the performance gain and phase loss in the present invention. In other words, better performance can be achieved by scheduling the use of one or more Q filters (scheduling the relative degree of the Q filters).

The low frequency vibration is less than or equal to 300 Hertz or any other low frequency external vibration and shock based on the dynamic vibration characteristics of the disc drive. The sample time can be less than or equal to the time it requires for a disc in the disc drive to rotate one complete revolution.

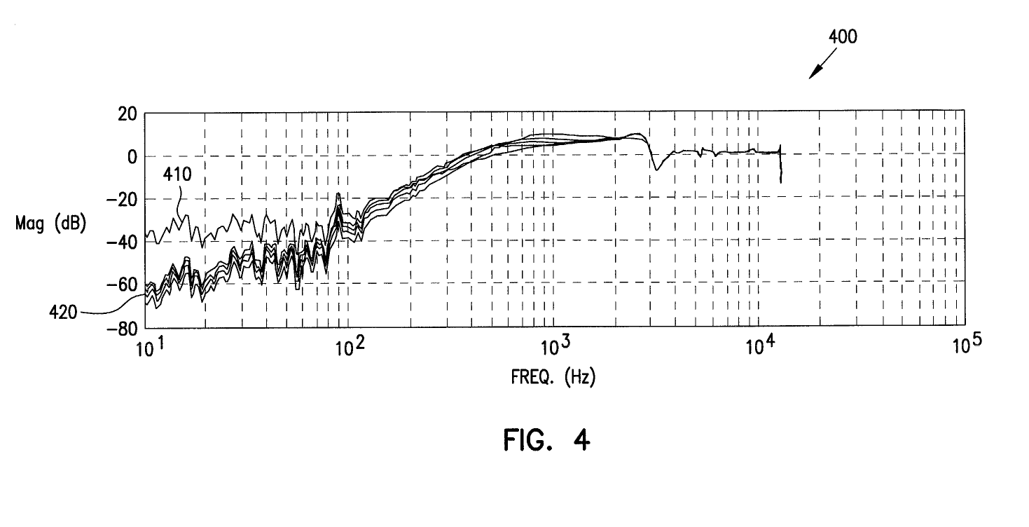

FIG. 4 is Bode plot 400 illustrating error transfer functions 1/(1+PC) obtained when using different compensation schemes (different combinations of Q filters). The error transfer function is a frequency domain measure that describes position-level output disturbance rejection capability. The smaller the magnitude of the error transfer function, the better the position-level output disturbance rejection ability. Graph 410 illustrates the error transfer function obtained using the prior art scheme (without the Q filters). Graphs 420 illustrates the error transfer function obtained using different combinations of Q filters. It can be seen from graphs 420 that different levels of attenuation can be achieved by using different combinations of Q filters. The left bottom most graph of graphs 420 is obtained using only one Q filter (the highest attenuation when the phase loss is the largest due to significant shock or vibration).

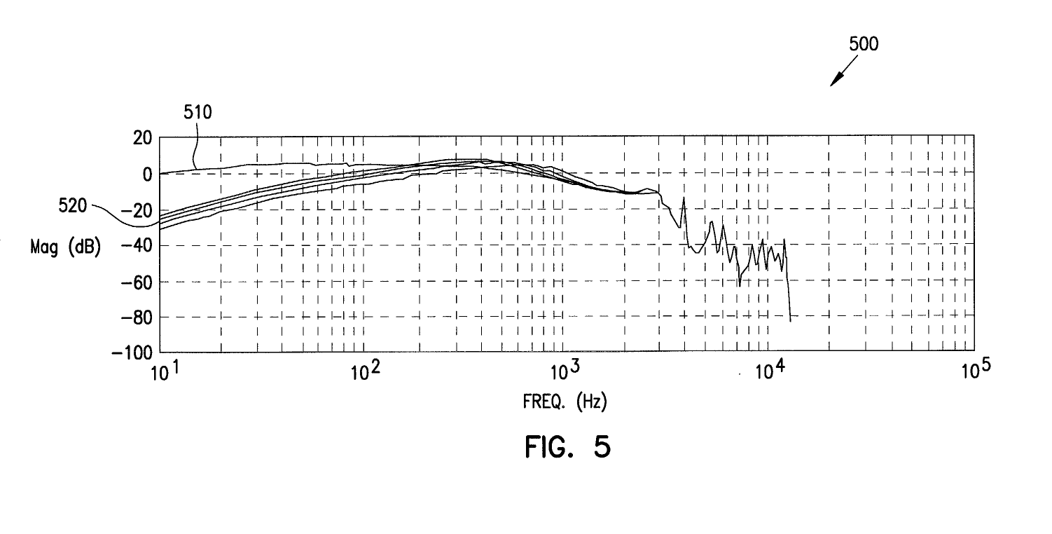

FIG. 5 is a Bode plot 500 illustrating torque-level disturbance sensitivity transfer function (P/(1+PC)). This is similar to the error transfer function shown in FIG. 4. Again the graph 510 is obtained using the prior art system which does not include the Q filter scheme of the present invention. Graphs 520 illustrate different levels of disturbance attenuation obtained using different combinations of Q filters of the present invention. It can be seen from FIGS. 4 and 5 that both the position and the torque level disturbances can be effectively attenuated by compromising between disturbance attenuation and phase loss.

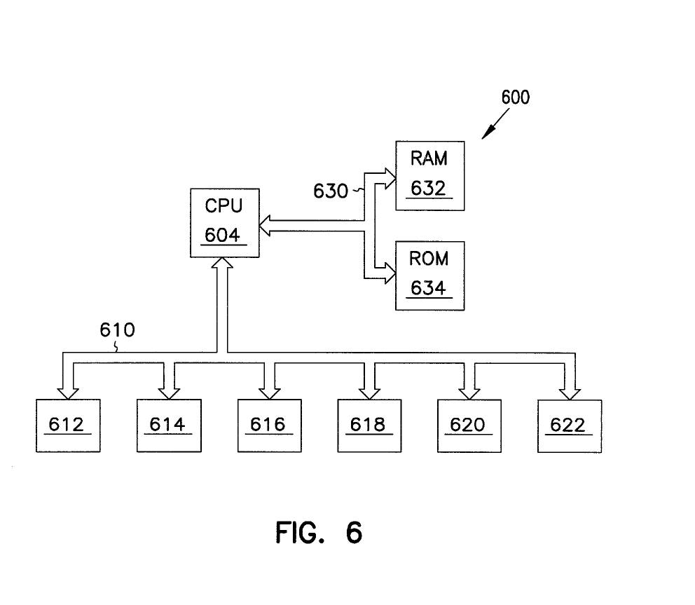

FIG. 6 is a schematic view of a computer system. Advantageously, the invention is well suited for use in a computer system 600. The computer system 600 may also be called an electronic system or an information handling system and includes a central processing unit, a memory and a system bus. The information handling system includes a central processing unit 604, a random access memory 632, and a system bus 630 for communicatively coupling the central processing unit 604 and the random access memory 632. The information handling system may also include an input/output bus 610 and several peripheral devices, such as 612, 614, 616, 618, 620, and 622 may be attached to the input output bus 610. Peripheral devices may include hard disc drives, magneto-optical drives, floppy disc drives, monitors, keyboards and other such peripherals. Any type of disc drive may include a servo controller to attenuate the force induced on the actuator arm by the external vibration and shock as described above.

Conclusion

In conclusion, a disc drive controller 300 generates a correction signal for attenuating an actuating force induced by external vibration and shock on an actuator arm assembly 120 of the disc drive 100. In this embodiment, the disc drive 100 includes at least one disc 134 rotatably attached to a base through a shaft 16. The disc drive 100 also includes an actuator 123 having a transducer head 126 and transducer 150 for reading and writing to the at least one disc 134. The actuator 123 carrying the transducer head 126 is in a transducing relation with respect to the disc 134.

The disc drive controller 300 including a servo controller 310 is coupled to the actuator arm assembly 120. The actuator arm assembly 120 is capable of moving the transducer head 126 based at least in part on an applied signal and correction signals from the servo controller 310. The actuator arm assembly 120 is also capable of generating a position error signal (PES) on a position of the transducer head 126 over a current track during a track following operation. The disc drive controller 300 further includes an analyzer 320 coupled to the servo controller 310 that measures the applied signal by the servo controller to the actuator arm assembly. Further, the analyzer 320 measures the position error signal during the track following operation within a sample time. Then, the analyzer 320 computes an acceleration signal from the measured position error signal. The disc drive controller 300 further includes a comparator 330 coupled to the analyzer 320. The comparator 330 compares the measured applied signal with the computed acceleration signal. The computation of the acceleration signal is explained in detail with reference to FIG. 2. Then the analyzer 320 further computes a correction signal based on the outcome of the comparison by the comparator 330. Then the servo controller 310 attenuates an actuating force induced by external vibration and shock on the actuator arm assembly 120 by applying the correction signal to the actuator arm assembly 120.

Also, discussed is a method 200 of attenuating an actuating force induced by external vibration and shock on an actuator arm assembly of the disc drive 100 shown in FIG. 1. The method 200 begins with step 210 of measuring an applied signal by a servo controller to the actuator arm assembly during a track following operation within a sampling time. The applied signal can be a voltage or current applied to the actuator arm by the servo controller to move the actuator arm assembly to a specified track during the track following operation. Step 220 includes measuring a position error signal during the track following operation within the sampling time. During track following, the servo information sensed by the transducer head is demodulated to generate a position error signal (PES), which is an indication of the position error of the transducer head away from the track center. In some embodiments, PES is measured using a sweep sine method routinely used in disc drive development.

Step 230 includes computing an acceleration signal from the measured PES within the sampling time. The acceleration signal is obtained by differentiating the PES signal. In some embodiments, this is accomplished by inputting the PES into a double-digital differentiator to recover acceleration information from the PES.

Step 240 can include delaying the measured applied signal to reduce a phase mismatch between measuring the applied signal and computing the acceleration signal.

Steps 250 and 260 include comparing the computed acceleration signal with the measured applied signal to obtain a correction signal. Steps 270 and 280 include attenuating the induced actuating force on the actuator arm assembly due to the external vibration and shock based on the outcome of the comparing. This is accomplished in steps 270 and 280 by filtering the correctional signal for low frequency external vibration to obtain a compensation signal and then applying the compensation signal to the actuator arm assembly to attenuate the induced actuating force, respectively.

It is to be understood that the above description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

What is claimed is:

1. A method for attenuating an actuating force induced by a disturbance on an actuator arm assembly of a disc drive during a track following operation, comprising steps of:
(a) measuring an applied signal to the actuator arm assembly during the track following operation within a sampling time;
(b) measuring a position error signal during the track following operation within the sampling time;
(c) computing an acceleration signal from the measured position error signal; and
(d) attenuating the induced actuating force on the actuator arm assembly due to the disturbance based on the acceleration signal and the applied signal.

2. The method of claim 1, further comprising:
(e) delaying the measured applied signal so as to reduce a phase mismatch between the measured the applied signal and computed the acceleration signal.

3. The method of claim 2, wherein the computing step (c) comprises:
(c)(1) differentiating the measured position error signal using a double-digital differentiator to compute the acceleration signal experienced by the actuator arm assembly during the track following operation.

4. The method of claim 1, further comprising:
(f) comparing the acceleration signal with the applied signal.

5. The method of claim 4, wherein the attenuating step (d) comprises:
attenuating the induced actuating force based on the outcome of the comparing.

6. The method of claim 4, wherein the comparing step (f) further comprises the steps of:
(f)(1) comparing the computed acceleration signal with the applied signal to obtain a correction signal; and
(f)(2) filtering the correction signal for low frequency external vibration and shock to obtain a compensation signal.

7. The method of claim 6, wherein filtering the correction signal to obtain a compensation signal of step (f)(2) further comprises:
(f)(2)(A) comparing the measured position error signal to a set of threshold values; and
(f)(2)(B) filtering the correction signal through one or more low pass frequency filters based on the outcome of the comparing the position error signal to obtain the compensation signal.

8. The method of claim 7, wherein attenuating the induced actuating force due to the external vibration and shock of step (d) comprises:
applying the obtained compensation signal to the applied signal to correct for the actuating force induced by the external vibration and shock during the track following operation.

9. The method of claim 1, wherein the measuring steps (a) and (b) are each performed within a time less than or equal to a time required for a disc in the disc drive to rotate once.

10. A disc drive, comprising:
a servo controller;
an actuator arm assembly comprising an actuator and a transducer head, coupled to the servo controller, which is capable of moving the transducer head based at least in part on applied and correction signals from the servo controller, wherein the actuator arm assembly is further capable of generating a position error signal based on the position of the transducer head during a track following operation; and
an analyzer coupled to the servo controller that measures an applied signal by the servo controller to the actuator arm assembly, and further measures the position error signal during the track following operation within a sample time, and wherein the analyzer computes an acceleration signal from the measured position error signal, and computes a correction signal based on the measure applied signal and the computed acceleration signal, and further attenuates an actuating force induced by a disturbance on the actuator arm assembly by applying the correction signal to the actuator arm assembly.

11. The disc drive of claim 10, further comprising:
a timing circuit coupled to the comparator to reduce a phase mismatch between measuring the applied signal and computing the acceleration signal.

12. The disc drive of claim 10, further comprising:
a comparator coupled to the analyzer compares the measured applied signal with the computed acceleration signal, wherein the analyzer computes a correction signal based on the outcome of the comparison, and wherein the servo controller attenuates the actuating force induced by disturbance on the actuator arm assembly by applying the correction signal to the actuator arm assembly.

13. The disc drive of claim 12, wherein the analyzer further comprises:
a double-digital differentiating circuit, to differentiate the measured position error signal to compute the acceleration signal.

14. The disc drive of claim 13, wherein the comparator further compares the position error signal to a set of threshold values, and issues a command signal based on the outcome of the comparison.

15. The disc drive of claim 14, further comprising:
one or more low frequency filters, coupled to the analyzer to filter the correction signal for a low frequency external vibration based on the command signal to obtain a compensation signal.

16. The disc drive of claim 15, wherein filtering the low frequency external vibration comprises:
filtering low frequency external vibration less than or equal to 300 Hertz.

17. The disc drive of claim 15, wherein the servo controller applies the compensation signal to attenuate the actuating force induced by the external vibration and shock during the track following operation.

18. The disc drive of claim 11, wherein the sample time comprises:
a time less than or equal to a time required for a disc in the disc drive to rotate one complete revolution.

19. A disc drive, comprising:
a positionable actuator arm assembly configured for supporting a transducer head adjacent a rotating disc; and
means for attenuating actuating force induced by disturbance on the actuator arm assembly of the disc drive by computing an acceleration signal from a measure position error signal during a track following operation.
